(19) United States
(12) Patent Application Publication
(10) Pub. No.: US 2003/0103069 A1
(43) Pub. Date: Jun. 5, 2003

(54) Navigator

(76) Inventors: Haakon Thue Lie, Billingstad (NO); Rune Hjertviksten, Stavanger (NO); Atle Lokken, Hafrsfjord (NO); Stig Ottosen, Stavanger (NO); Henning Sundby, Sandnes (NO)

Correspondence Address: OBLON, SPIVAK, MCCLELLAND, MAIER & NEUSTADT, P.C., FOURTH FLOOR, 1755 JEFFERSON DAVIS HIGHWAY, ARLINGTON, VA, 22202, US

(21) Appl. No.: 10/111,976

(22) PCT Filed: Aug. 30, 2001
(86) PCT No.: PCT/NO01/00353

(51) Int. Cl. G09G 5/00

(52) U.S. Cl. 345/700

(57) ABSTRACT

This invention relates to accessing, publishing, and navigating in online or locally stored computer based multimedia content. This information space is at least a 2D experience space in which all content is tagged, and the method comprises displaying a movable, expandable and collapsible navigator area on a display or projecting means connected to a data processing system interacting with the information space. A point or an area on the navigator expressing a desired experience is selected, and accessing, publishing and/or navigating in available content performed by mapping the selected point or area on the experience space. The invention allows users of computer systems, such as PCs, handheld devices or TV sets, to access content by using a separate, unique navigator presented on the display device, jointly with the content. The content may be presented in a browsing program, or run on the operating system of the device itself.

### FIELD OF THE INVENTION

This invention relates to accessing, publishing, and navigating in online or locally stored computer based multimedia content. Also uses of the invention as well as a computer program product are disclosed.

### BACKGROUND OF THE INVENTION

The invention is firstly aimed at learning and education. Here standards like [SCORM], which references several other standards, defines tagging of learning content and courses. This area, education, can be seen as a subset of general experiences, which can be modeled in a 2D plane according to [Pine, Gilmore]. The Pine and Gilmore model is shown in FIG. 1.

The model in FIG. 1 is based on the view that an experience is made by mass customization of a service, in the same manner as a service can be viewed as mass customization of a product, and a product can be viewed as mass customization of goods. Thus, the term “experience” is not used only as in the cognitive sciences, but also in line with the economical terms of “goods”, “products” and “services”.

Experiences can take place both by participation or observation of an event. The experience can either modify future behavior, or just create feelings or emotions.

Now, in FIG. 1, the x-axis is used for showing the degree of participation in an experience, i.e. how much a person or a group of persons, use their mental capacity to take part in the experience. “Passive participation” could also be termed “observation”.

The y-axis is used for showing the degree of behavioral change one could expect from the user's participation. The term “immersion” is used when the experience only creates emotions, whereas “absorption” is used when the experience occupies the entire mind and creates memories or changed behavior.

Then, in FIG. 1, terms are used to overall describe the quality of the experiences in the four quadrants. Esthetics requires only observation and creates only emotions (e.g. music in an elevator to make people relax). Entertainment is observed and creates memories (e.g. a sing and dance show). Escapist experiences demands active participation, and creates emotions (e.g. rafting in a rough river creates fear and joy). Education creates memories and changed behavior, and needs participation (e.g. learning a procedure for a train by using a web-based simulation).

(Note: Other terms could also be applied to parts of this 2D space, e.g. as shown in FIG. 6.)

The model in FIG. 1, allows for a systematization of a set of experiences, and thus for navigation in this set. A navigator is a device making navigation possible. As this model makes all education a part of a 2D experience space, a navigator aimed at e.g. educational content, could also make navigation for other content possible, if generic features of this space are taken into account.

To allow navigation, the content must in some way be tagged to allow systematization and sorting. Now—although there is tagging aimed for music (e.g. the IDS informal standard, used in MP3-players) and at general multimedia content [MPEG7], no navigators has been made, according to the knowledge of the inventors, that covers more than one of the tagging systems, that is—there are no navigational tools that comprehends the total experience space. Also, no tagging system has been made for this, aside from general ontology frameworks, such as The Ontology Interchange Language (OIL), a Web-based representation and inference layer for ontologies, that builds upon the W3C's RDF/RDFS specifications.

An ontology is a consensual, shared and formal description of the concepts that are important in a given domain. Typically, an ontology identifies classes of objects that are important in a domain, and organizes these classes in a subclass-hierarchy. Each class is characterized by properties shared by all elements in that class. Important relations between classes or between the elements of these classes are also part of an ontology. Ontologies are now an important notion in such diverse areas as knowledge representation, natural language processing, information retrieval, databases, knowledge management, multi-agent systems, and others. [http://www.ontoknowledge.org/oil/OIL-FAQ.html#acronym].

A standard such as MPEG7, ID3or SCORM makes it possible to embed information and tags in other notations. Having a navigator understand more than one tagging system is thus known technology—whereas transforming these systems to a unified navigational space presented within one navigator, is not.

An experience (e.g. a show or a learning program) can be compiled from several modules with multimedia content. Another problem for the user is then that often multimedia content is presented with separate navigational mechanisms embedded in the content or in a player, suited for that particular content. Thus, navigation in the totality is lost, or is hardly accessible.

When it comes to publishing content, there is a need for informing users what type of experience the content can give. Educational content is often published and administrated using Learning Management Systems (LMS). These systems keep track of users and the learning process. An LMS will mostly follow standards, such as SCORM, and thus make content available using tagging. The LMS may have some sort of navigator for the user, often in the form of lists, or catalogues, similar to those used in general for file folders on the Internet. In some systems administrators can compile sets of content in order to make educational courses from existing and new content.

U.S. Pat. No. 5,933,599: “Apparatus for presenting the content of an interactive on-line network” is another principle of making the information in a network available and possible to navigate in. Here the content is presented in a tree structure, which is an extension of the structure in the operating system. This is a way of presenting on-line content where metadata relating to the possible usage of the content is not used for navigation.

U.S. Pat. No. 6,012,055: “Mechanism for integrated information search and retrieval from diverse sources using multiple navigation methods” describes a way of navigating; using several navigator interfaces in combination, where metadata is used. This way of navigating is based on a way of finding content where several questions are asked or a structure is browsed, using embedded navigators. This way a particular content can be found in several steps.

In these methods the navigator is used primarily for finding content and does not include navigation and other features within a set of found content.

Several companies like US-based Real and Microsoft have products (e.g. “Real player”, “Windows Media Player”) that has navigational buttons, and can compile lists of content, using metadata. However all these applications depends on playing and displaying the content, e.g. audio and video files of various formats, within the application itself.

Now, the inventors considered the concepts above and known technologies, and found that these could not solve the problem of how to navigate in and use a compiled set of content, e.g. a modular course, where the modules can be in any file format. This implies that the modules can also be tagged with metadata in one or more of several systems, and the end result could again be tagged. Another problem is that known navigational bars or frames tend to visually disturb the experience of the content.

Another consideration by the inventors was how educational content, or other experiences, can be accessed when needed, in the setting of the user working with other applications. A common way of solving this, is to have the user explicitly choose the content by opening another application, e.g. by a choice in the menus of the said application or the operating system. This will then in known solutions often bring the user into an “electronic classroom” where the content can be chosen, i.e. the user is mentally removed from the present tasks. From an instructional design point of view (when thinking about educational content—or e.g. from a director's point of view when thinking entertainment as another type of experience) this is a limitation in how content is presented to the user.—and a better solution as presented in this invention, is to have the choosing mechanism readily at hand.

### SUMMARY OF THE INVENTION

According to a first aspect the invention comprises a method for accessing, publishing and/or navigating in a digital information space, the information space being at least a 2D experience space in which all content is tagged. The method comprising: displaying a movable, expandable and collapsible navigator area on a display or projecting means connected to a data processing system interacting with the information space, selecting a point or an area on the navigator expressing a desired experience, and accessing, publishing and/or navigating in available content by mapping the selected point or area on the experience space.

According to a second aspect the invention comprises a navigating device for accessing, publishing and/or navigating in a digital information space, comprising a movable, expandable and collapsible navigator area displayed on a display or projecting means by a data processing device interacting with the information space. The information space is at least a 2D experience space in which all content is tagged. The navigator area is linked to the content in the information space by a mapping function.

Categories of experiences (e.g. learn, watch, do, be) are expressed in an orthogonal coordinate system and serves as basis for designing the navigator area, and thereby the link to the content in the information space. The navigator is always displayed in front of, and partly disengaged from, other applications running in the data processing system. The navigator can e.g. be used for accessing, publishing, and navigating in educational content.

According to a third aspect the invention comprises a computer implemented method for interacting, accessing, publishing, and/or navigating in a digital education space in which all content is tagged. The method comprising: displaying a movable, expandable and collapsible navigator area in front, on a display or projecting means connected to a data processing device, selecting a point or an area on the navigator expressing the desired action, and mapping the selected point or area on the education space for executing the desired action.

Students can easily publish content to the education space by indicating a point or an area on the navigator, whereby the content is appropriately tagged and subsequently published. In this way knowledge can be shared and made accessible for others in a simple way.

In a fourth aspect the invention comprises a navigating device for accessing, publishing, and/or navigating in a digital education space in which all content is tagged, comprising a movable, expandable and collapsible navigator area displayed on a display or projecting means connected to a data processing device interacting with the education space, the navigator area being displayed in front partly disengaged from other application programs running in the processing device and linked to the content in the education space by a mapping function.

In a preferred embodiment the navigating device is embedded in a learning management system, and the navigator area then gives access to administrative functions for a set of educational content. However, the navigator area is divided into regions for accessing educational content, accessing resources, communicating with other users of the education space and communicating with the learning management system administrator. An education space can be a personal subset of an educational space for a group of users. Also, the invention comprises an education tracking device monitoring the content experienced by the user, and which is being graphically displayed on the navigator area.

Navigational buttons on the navigator area may give access to coaching, setting bookmarks and linking to other related content with an URL (universal resource locator).

In a fifth aspect the invention concerns a computer program product for a data processing system comprising a computer readable medium, having thereon a computer readable program means which, when loaded into an internal memory of a data processing system, makes the data processing system one perform of the methods above. The computer program product for a data processing system may also comprise computer readable code means which, when loaded into an internal memory of a data processing system, makes the data processing system perform one of the methods described above.

The present invention provides an easy way of accessing, publishing and navigating in educational content, such as courses, and in the whole experience space, and other experience content, such as entertainment or art. The content may be of asynchronous or synchronous nature, and may involve other users of the content. The content will usually consist of a set of content elements that may have differ ent characteristics with respect to presentation form (i.e. text, multimedia, audio) and software, hardware and network requirements. This set can be compiled by the user, by a content packager (a person or a computer) or by an administrator e.g. in a Learning Management System.

The invention allows users of computer systems, such as PCs, handheld devices or TV sets, to access content by using a separate, unique navigator presented on the display device, jointly with the content. This content may be presented in a browsing program, or run on the operating system of the device itself. The invented navigator operates logically with respect to the set of content elements present in e.g. the browser, and not logically with respect to the each content element that has been presented. So, e.g. using a “backward” or “forward” button on the navigator navigates in the content set, and not in what has been presented on the device.

Thus, the invention provides the user with a single navigating device, readily at hand, for learning content or in a broader sense for experiences The navigator may be collapsed to an icon, or a recognizable dot, and be expanded by clicking or otherwise selecting it. The invention is stated in the appended claims.

### BRIEF DESCRIPTION OF DRAWINGS

Example embodiments of the invention shall now be described in detail with reference to the accompanying drawings, where:

FIG. 1 is a model of an experience space adapted from [Pine and Gilmore];

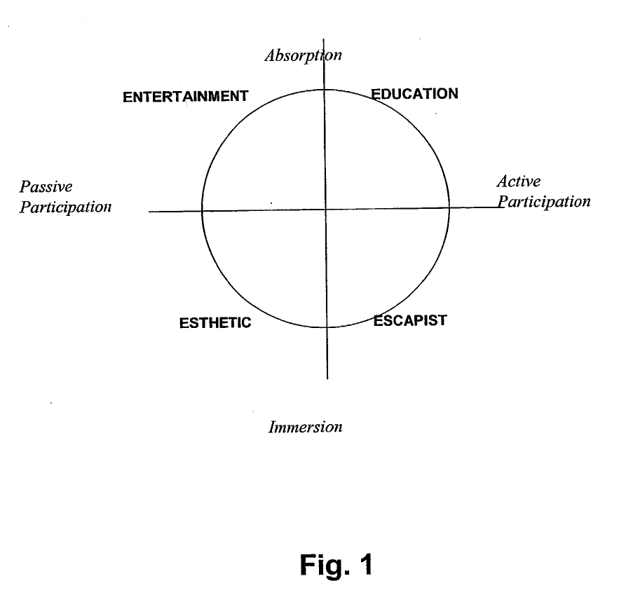

FIG. 2 is a screenshot where a Navigator according to an embodiment of the invention is embedded in a Learning Management System;

FIG. 3 is a screenshot where the Navigator is in front of a training program. It can be freely moved, collapsed or expanded. Here a button for contacting a mentor has been activated on the navigator. A separate window is used for this communication;

FIG. 4 shows the Navigator, marked with an arrow, collapsed and on top of another application; a word processor. By clicking or choosing the navigator will expand;

FIG. 5 shows an expanded Navigator according to an embodiment of the invention, giving access to a list of content in accordance with the user's choice after e.g. a search. The navigator is in front of another application, a browser, used for displaying educational content;

FIG. 6 shows an expanded Navigator showing an available experience space according to an example embodiment of the invention;

FIG. 7 is a drawing showing several processing devices with navigators sharing a database with the mapping data used for accessing content—here an experience space is implemented by using several content repositories in a network; and

FIG. 8 is an example embodiment of the invention showing a client with the navigator and servers.

### DETAILED DESCRIPTION OF THE INVENTION

A learning management system (LMS) is a subset of a knowledge or experience content management system. Such a system consists in general of:

a general and shared database or repository or distributed structure for storing content. The content is tagged (e.g. SCORM), and thus is a part of the experience space.

a personal subset, e.g. in a sub-database or a separate structure, containing the information chosen by an individual or a group, present on the network or in a device, such as a TV set top box, a computer or a mobile terminal.

A network, open—such as the Internet or the GSM mobile network, or closed—such as a LAN, connects the user with the databases and other users. The information is accessed through a computer, mobile terminal, handheld device or TV-set with computing capacity and with a display such as a CRT-display, LCD-display, a projecting mechanism e.g. on a screen or on the eye of the user. Any input devices (one or more to be used simultaneously), such as a keyboard, stylus, mouse, touch screen, movement detector, haptic device or positioning sensor can be used.

A general knowledge or experience content management system consists of similar components as an LMS. Other examples of such existing systems are management systems for handling video or audio content for personal use over broadband connections.

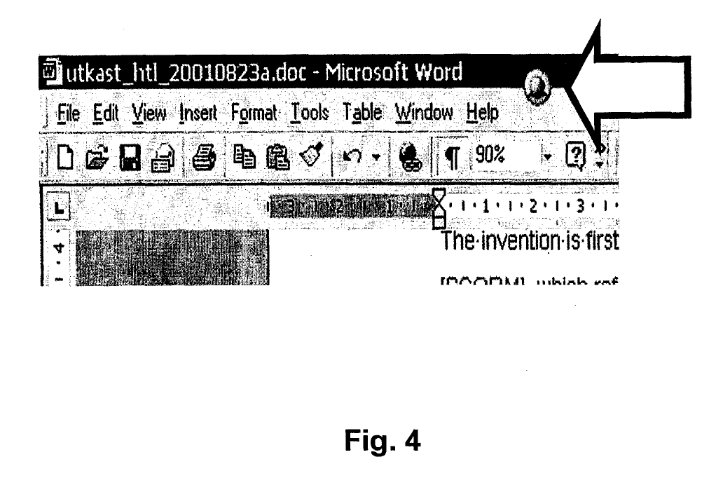

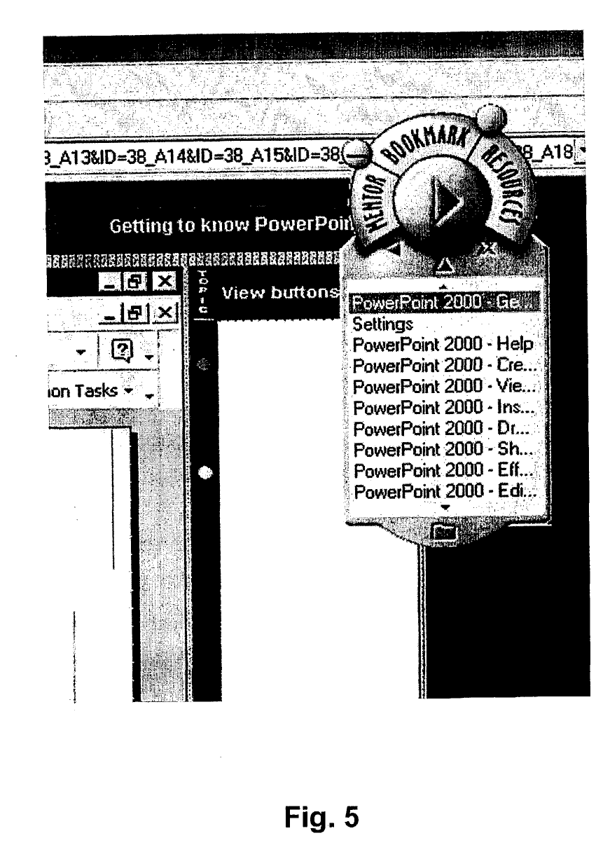

On such a system is the invention introduced: A navigator, shown either in one of its expanded modes (e.g. FIG. 5) or as a collapsed dot (see FIG. 4). This is achieved by using standard programming methods for making an application suitable for the used device, and the program code for this application is either present on the device or downloaded as needed over the network.

The navigator is either started by the user or as a part of the device's start up programs. Alternatively, the navigator is started, when relevant content is accessed. The user chooses content available from a list or a view presented by the navigator.

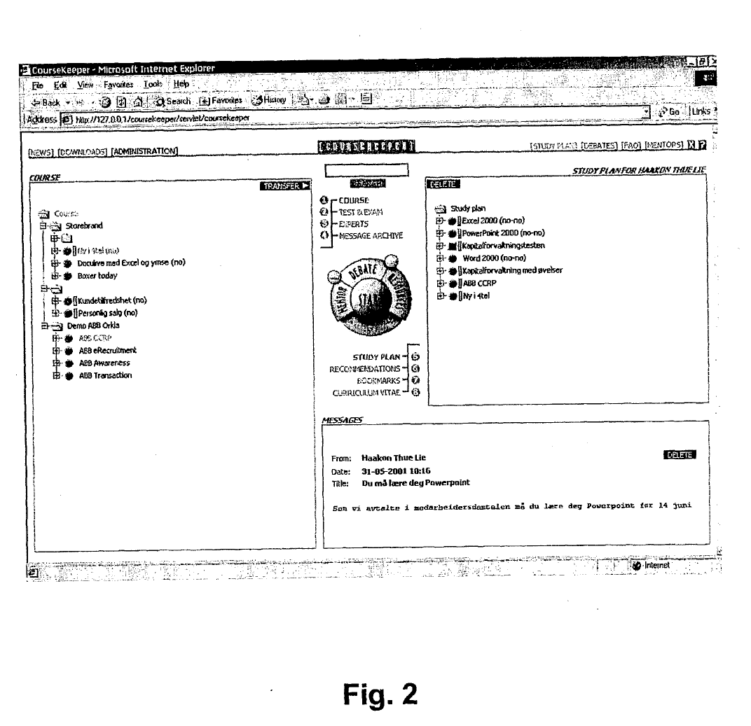

In FIG. 2 an embodiment of the navigator is shown on a Learning Management System (LMS) that gives access to administrative functions for a set of content. In this case the whole experience space is administrated through the LMS, and the navigator is used to give the user a consistent tool for communicating with the underlying systems, e.g. starting the experience. The LMS in this figure gives the user an additional interface for searching and choosing relevant content, as well as other administrative functions. There could also be other applications interfacing the navigator directly or indirectly.

On the left hand side is a subset of the experience space chosen as relevant by an administrator for groups of people that this user belongs to, e.g. a department in an organization or a profession. The user then transfers selected courses to the list on the right hand side—which is a personal list of content the user wishes to have readily accessible through the navigator.

The user could choose one or more courses (the course being a subset of the experience space), and then launch it using the navigator. The navigator could then trigger the LMS to launch the next element in this chosen set, as the user presses the forward button. This will then launch an application suited for displaying the chosen content, e.g. a web browser, as defined in the underlying operative system.

The content elements in a subset can have any format. In FIG. 2, available subsets of content are shown as folders and dots on the left hand side. Chosen subsets are shown on the right hand side. Each subset can be expanded to show its elements—and these elements are usually files or streaming media. As the content can be streaming video, the invention is also applicable to TV sets and Electronic Program Guides. This is also why it is important that the navigator has knowledge of the capacity needed for viewing the chosen content; the processing device needed for viewing a streamed TV-show is very different from what is needed to view a picture or read a text.

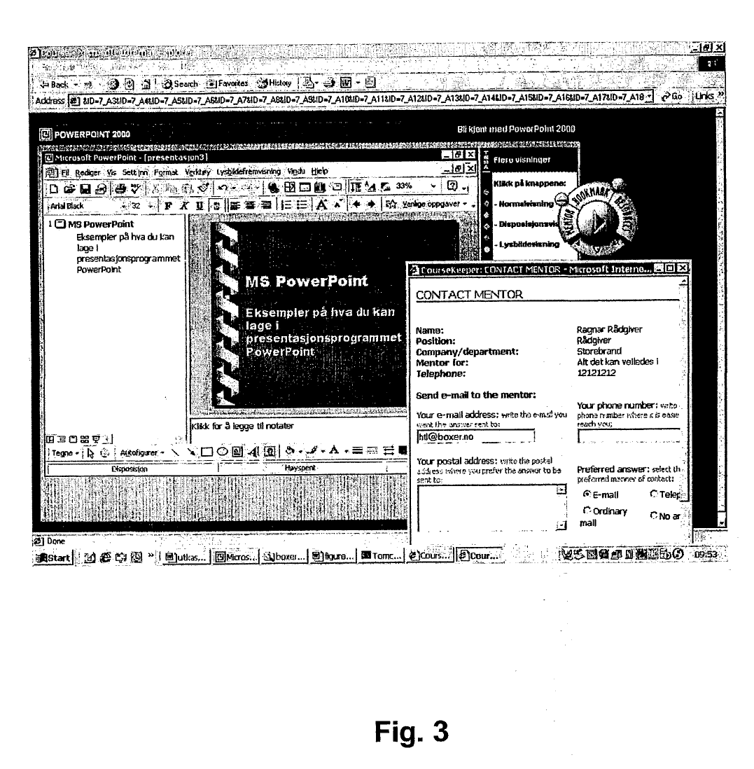

The navigator is always displayed in front of the chosen content, as shown in FIG. 3. Other functions are also available on the navigator area, like contacting a coach or mentor, as shown in FIG. 3. Here an asynchronous communication application as e-mail has been triggered. However, the communication application could also be synchronous such as telephone, chat or videoconferencing.

The navigator can be connected to the operative system of the data processing device through common programming methods and the application-programming interface (API) as documented for each type of operative system.

The navigator can also be collapsed, as shown in FIG. 4. It will then still be movable and be in front of any application—thus it is always easy accessible when using an application, e.g. for word processing, and may be expanded at will in order to access content from the experience space. When content is displayed, the navigator can be present in a way which minimally disturbs the visual part of the experience.

As shown in FIG. 5 the navigator embodies navigational buttons. There are three essential types of buttons on the navigator:

1. Buttons related to the navigator's modi of operation. (e.g. the “-” button minimizing the navigator, or the handle used to move the navigator around)

2. Buttons related to operations on the chosen set of content, such as the play button “>”, the back button “<”or the quit button “x”, as well as a view, or list, of what content the navigator currently operates on “v” and “Λ”, respectively. This list, as well as other parts of the navigator, can be displayed in separate windows (e.g. as in FIG. 3).

3. Buttons related to the process the user is engaged in, when accessing the content, such as:

Contacting relevant persons such as a coach, mentor or co-user. This contact may be synchronous or asynchronous.

Adding a bookmark, to be able to return to the content, and adding a note, written or in other forms.

Accessing a list over other relevant resources, provided by a relevant person, as above. This list could e.g. be in the form of URL's with a short explanation.

The navigational buttons are linked to the chosen content elements, and is used for navigating in a consistent way, independent of other navigational tools, such as those in a browser, in the content itself (e.g. a hyperlink within the content), or in the operating system of the computer system.

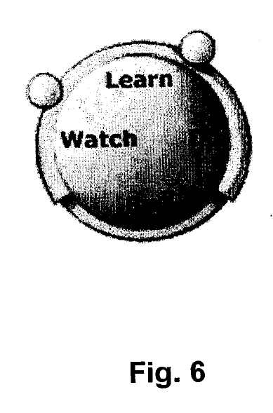

The navigator, as described above, is only used in a given part of the available experience space. FIG. 6 shows how the navigator may also contain a fourth type of button, with an input sensitive area for choosing a point or an area in the experience space, indicating the type of content wanted. This button can be available in several ways, e.g. in the beginning of a session, where choice of content is a typical action, and later by performing an appropriate action on the navigator.

As this area, and if needed the navigator itself, expands, it covers more parts of the experience space (i.e. different from U.S. Pat. No. 6,012,055 which is more like nested navigators)—e.g. if it was covering the educational part, expanding it, may open other areas of the experience space, like entertainment.

This type of button can also, as shown in FIG. 3, open separate windows, used for displaying the navigation area in a more convenient way.

The navigation in the available content is done by mapping the experience space on the navigator, so that in search for content, the used model, e.g. the one by [Pine & Gilmore] can be used in combination with a general keyword search. Thus the navigation is done e.g. by clicking or tapping or otherwise selecting a point or an area in the experience space, optionally combined with keywords given, e.g. in writing or by speech, and combined with knowledge of the capabilities of the user's platform (handheld device, TV set etc.).

An example: The user gives the keyword “rose” to the navigator and indicates by tapping at the screen, a point on the navigator (if Cartesian coordinates are used e.g. registered as)—0.5-0.3i, i.e. an esthetic experience. Given knowledge of the handheld platform, a painting of a rose is chosen. If an entertainment experience is chosen on a TV-set—e.g. the film “The Rose” would come as an alternative, together with the song sung by artist Bette Midler.

Now, for a more precise search, more keywords could be used. This example illustrates that the invention allows navigating in a set of content giving experiences in accordance with the user's choice.

The navigator contains a mapping function, where the inverse function also works between tags and coordinates in a 2D plane. The inverse function is to be used for publishing.

The tags used in the content, e.g. ID3, is simply a string of search words including the name of the artist, the album, the song title and the genre, like rock or dance. In MPEG7and SCORM the formalism of XML is used for defining categories of tags. The mapping of the navigator is done in order to visualize these categories to the user, and to have a common interface when navigating in content tagged in different systems. Also—content, e.g. in the form of separate tagged files, can be compiled to a set that has to get a new tagging, which the person compiling this set finds suitable.

The mapping can be done by each individual having a separate mapping table, by a common one for all users or by a common one but with personal additions. The mapping table can be stored in a database on the network or in the same device on which the navigator is present. Then, a difference from known systems is that the metadata relevant for the user is in general not stored in the files of the content itself, but in separate databases. If content is exchanged between users, also the mapping information can be exchanged, e.g. by using a peer-to-peer protocol.

Tags are either present in the content, prepared by its maker, or added by others or the user itself. The tags may be in accordance with any ontological framework. Various authentication schemes may be used for verifying the validity of the tagging, if provided by others than the user [e.g. like VeriSign does now, in respect of certifying that the author of a program is known].

Also tags may be introduced by the user, which overrides the provided tags. Also a group can gather tags and average values may then be presented.

The available content is stored in a personal repository, cache, database or other storage medium, and is indexed in accordance with well-known standards, e.g. based on XML tagging and RDF from W3C as semantic framework. The navigator only presents content which is suitable for the device used; e.g. for a low capacity handheld device other content is presented than for a TV-set or a PC. (Tags for this are a part of e.g. MPEG7).

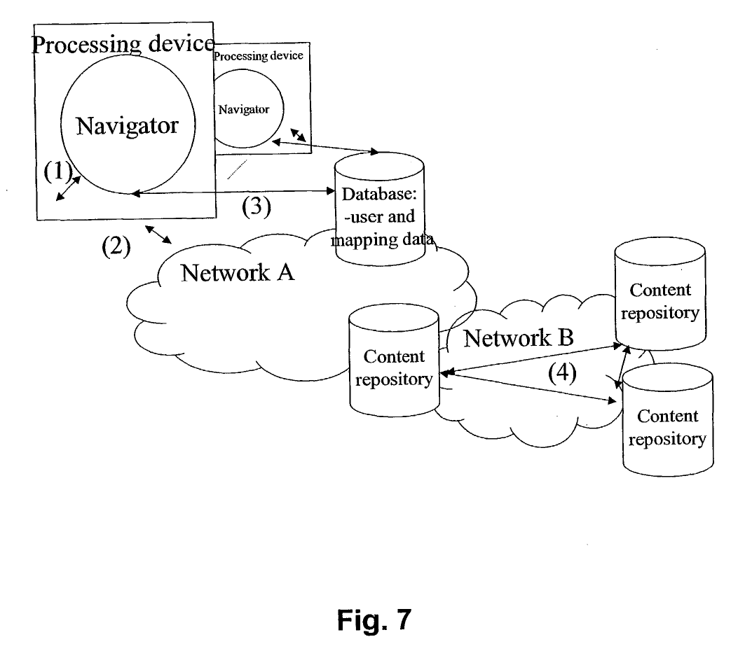

In FIG. 7 is an example embodiment where the navigator is an application on a processing device. The navigator communicates 1 with the operative system of the processing device, and can then use the communication channels offered by this operative system towards a network 2. These channels are in particular used to reach 3 a database, holding user data (e.g. performs authorization, tracks usage, has knowledge of sets of content accessible for this user). As a result of mapping in the database, the navigator can access content from a content repository through the operative system and communication channels 2, or only through the operative system if the content resides within the processing device Several processing devices with navigators can share a database with the mapping data used for accessing content, i.e. the experience space. In FIG. 7 the experience space is implemented by using several content repositories in a network.

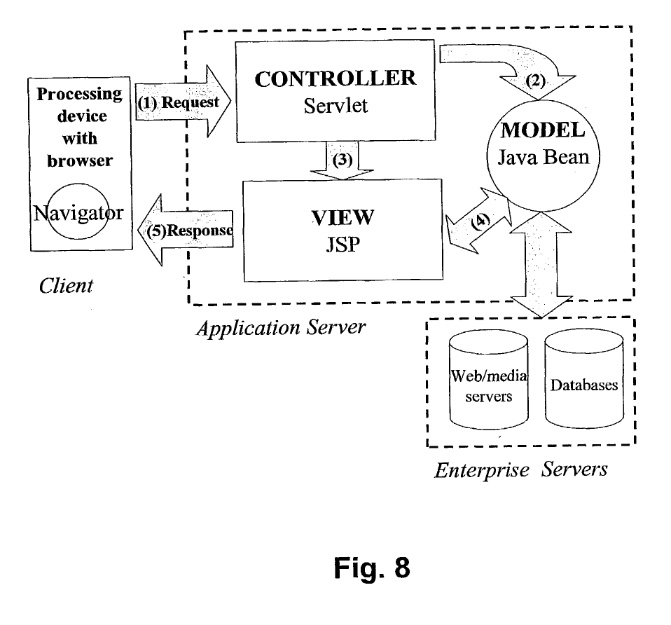

In FIG. 7 content is accessed through communication channels 2 and Network A. As Network A (e.g. a LAN) is connected to Network B (e.g. Internet), content can be accessed also from repositories in Network B. Content repositories connected to Network B, exchange content 4, so that content published on one of them becomes a part of the experience space accessible from that repository. This is useful if a database and a repository is used by one group of users, and other users located far away use another pair. Sharing of content can take place using any replicating methods. It could also be combined with a user or users searching for content, and then a peer-to-peer protocol such as “Gnutella” can be used. This peer-to-peer exchange of content can be controlled by the controller shown in FIG. 8. The controller also controls the mapping of this content, and can control transfer of content to a storage medium on the processing device itself. This could be necessary, e.g. if this device is a mobile terminal not always connected to a network.

On the upper left-hand side of FIG. 7 are two processing devices, and an indication that there could be any number of them, accessing one database and using its own communication channels as in 2 to reach the repository in Network A. This is a typical configuration in an organization using the invented navigator as part of a Learning Management System.

FIG. 8 shows an example embodiment with some implementation details. The client on the left hand side of the figure is using a browser to request 1 using an ordinary call via world wide web with an URL like “http://ckrk4.boxer.no/coursekeeper/news.jsp?language=en” where “ckrk4.boxer.no” is the address of the Application Server, “Coursekeeper” is the name of the catalogue on that server containing the code for a part of the clientserver system used for controlling the navigator “Controller”, and “news.jsp?language=en” asks for a start page developed using “java server pages” (JSP) in English language. If this is a new request, a “Model” of the service for the navigator is instantiated 2 using “java beans” technology known in the art. Then a “View” is generated by a message from the Controller, using JSP 3. The View informs the Model that an English language “news page” is welcoming the user and the model returns the known user data for that particular user, 4 and this response is returned to the browser5 including a command for activating the navigator. In this example embodiment, the code for the navigator is either already present in the client as a browser plug-in (if it is not, a request for transfer of the code for this is transferred using Java or Active-X) and user identification is taken from the client's operative system. The browser now displays for the user something similar to the screenshot shown in FIG. 2.

FIG. 8 shows that the Application Server is connected, e.g. through a network, to one or more Enterprise Servers and data sources. If now a new request 1 is made, e.g. from the user selecting a point on the navigator to get an educational experience in presentation techniques, the Controller processes this and asks the View 3 to generate a response 5. The View communicates with the Model, and here there is a request from the Model to a database located on an Enterprise Server, as shown on the right hand side of the figure. In this database the mapping between the point chosen on the navigator and the appropriate content is available from the users sub-set of the experience space, and its URL. This finally results in the View sending a response 5 to the browser with the URL to the chosen educational experience, which is displayed. The user then wants to contact a mentor. The same process takes place in steps 1, 3, 4 and 5. Now the View generates, by using JSP, a browser window with possibilities for contacting the Mentor. This is the result shown in FIG. 3.

As FIG. 7 and 8 show, in some embodiments the navigator will be implemented in close connection with the system managing the experience space, such as an LMS. Parts of the code for the navigator can then be embedded in the code for this system. However a navigator can also be made with a well-documented application-programming interface. If the said management system supports this, the navigator can be chosen by the user to replace the system's ordinary interface upon installation. In the same way could one navigator access several management systems, each managing a part of the experience space.

This example embodiment uses a relational database to store user data, and also to store the mapping between inputs on the navigator to choose content, and the URL to the content available from the experience space. This mapping decides the users available subset of the whole content of the experience space. Most content is then physically stored on one or more web servers, in FIG. 8 as a part of the Enterprise Servers/Data Sources on the right hand side. In FIG. 7, this is the content repository, and is here shown as a separate logical entity. The database is also a separate logical entity.

The navigator could also allow the user to indicate to agents, i.e. separate programs that can search continuously for specified information in a network, and return the found information, which types of content are of interest or which content providers are preferred to fill the repository. This can be done by assigning domains or root-domains (such as .edu or .jp ) to limit the search.

The navigator may contain user identification, as a result of a login procedure on the navigator or a related system.

The navigator can be used for publishing content to the experience space. Then the user will mark the content and use the navigator as means for appropriately tagging the content to be published. This implies that the navigator communicates with an application used for publishing on the networks constituting the experience space. Alternatively this function could be a part of the operating system of the data processing device.

As an example, using a word processing program, a poem has been created. In order to make it available to others, a publishing menu selection is activated in the word processor (“save as experience”). This triggers the navigator, which then is used for selecting the appropriate areas or point in the experience space and gives access to inputting more information relevant for tagging, such as types of emotions triggered by the poem. Other information used for tagging, such as language, could be retrieved from the word processor or the operative system.

The navigator may be used as a tool for displaying statistics about the content experienced by the user. An experience tracking record could be viewed as a vector or trace indicating the users choices over a period of time. It could be displayed on the navigator using marks or shades indicating what areas have been covered, thus assisting when choosing new content.

Communication with other users or mentors/coaches can either be trigged by a separate button on the navigator, as shown in FIG. 3, and this again triggers mechanisms like mail or videoconferencing by using the operative system of the processing device. Also, content itself could imply communication; e.g. a chat channel can be meta tagged and started as content.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

### REFERENCES

Model for experiences:

B. Joseph Pine II, James H. Gilmore: The Experience Economy, Harvard Business School Press, Boston, Mass., USA pp30

Agent technology:

Donald Schrooten, Ivo van den Maagdenberg, Starlab, Zaventem, Belgium: Agent technology for search and selection of MPEG-7 annotated Audio Visual Content, ACTS/AC308/DICEMAN/1998

Tagging and systems for e-learning and Learning Management Systems:

Sharable Courseware Object Reference Model SCORM Version 1.0 January, 2000—www.adlnet-com

Tagging and systems for searching in MPEG conformant content:

MPEG-7 Overview (version 3.0), ISO/IEC JTC1/SC29/WG11 N3445, Geneva, May/June 2000 (http://www.cselt.it/mpeg/standards/mpeg-7/mpeg7.htm)

Informal standard Document: id3v2.3.0.html at http://www.id3.org/; M. Nilsson Feb. 3, 1999

Tagging and systems for general www content

Resource Description Framework (RDF) Model and Syntax Specification, W3C Recommendation Feb. 3, 1999, http://www.w3.org/TR/REC-rdf-syntax/

The Ontology Interchange Language (OIL), a Web-based representation and inference layer for ontologies, builds upon the W3C's RDF/RDFS specifications vhttp://www.ontoknowledge.org/oil/downl/oil-whitepaper.pdf.

1. A method for accessing, publishing and/or navigating in a digital information space, the information space being at least a 2D experience space in which all content is tagged, the method comprising,
displaying a movable, expandable and collapsible navigator area on a display or projecting means connected to a data processing system interacting with the information space,
selecting a point or an area on the navigator expressing a desired experience, and
accessing, publishing and/or navigating in available content by mapping the selected point or area on the experience space.

2. Method according to claim 1, wherein the experience space comprises sets of content elements.

3. Method according to claim 1, wherein the mapping is combined with a keyword.

4. Method according to claim 1, comprising collapsing the navigator in order not to disturb the desired experience.

5. Method according to claim 1, comprising expanding the navigator for covering more of the content in the experience space.

6. Method according to claim 1, wherein the navigator checks or knows the total processing and communication capacity of the data processing system.

7. Method according to claim 1, comprising using an agent system for collecting content offline or online.

8. Method according to claim 1, comprising publishing new content, including tagging, in the experience space compiled from pre-tagged content from other users, professional content developers or organizations that systemize content.

9. Method according to claim 1, comprising establishing an asynchronous or synchronous communication channel between other users of the content or other predefined persons or applications.

10. Method according to claim 1, wherein when selecting a point or area in the original 2D space, the navigator allows choosing one or two new dimensions.

11. Method according to claim 1, wherein selecting is performed by a user by using an input device such as a keyboard, stylus, mouse, touch screen, movement detector, haptic device, speech recognition device, or positioning sensor.

12. Navigating device for accessing, publishing and/or navigating in a digital information space, comprising a movable, expandable and collapsible navigator area displayed on a display or projecting means by a data processing device interacting with the information space, the information space being at least a 2D experience space in which all content is tagged, and the navigator area being linked to the content in the information space by a mapping function.

13. Navigator according to claim 12, wherein categories of experiences (e.g. learn, watch, do, be) are expressed in an orthogonal coordinate system and serving as basis for designing the navigator area, and thereby the link to the content in the information space.

14. Navigator according to claim 12, wherein the navigator area is expressed/represented by coordinates e.g. sets of complex numbers.

15. Navigator according to claim 12, wherein the content comprises a variety of information (e.g. audio, video, e-learning), and that at least two tagging systems are represented in the content.

16. Navigator according to claim 15, wherein the content comprises tagging systems aimed for music (e.g. IDS), general multimedia content (e.g. MPEG7) or educational content (e.g. SCORM).

17. Navigator according to claim 12, wherein the experience space comprises a set of content elements assigned to a user or a group of users.

18. Navigator according to claim 12, wherein the experience space comprises a peer-to-peer structure, e.g. such as a set of computers connected with the “Gnutella” protocol.

19. Navigator according to claim 18, wherein repositories in the peer-to-peer structure is an identifiable subset, e.g. by organization or geography or domain, of the entire information space.

20. Navigator according to claim 19, wherein the subset is chosen from a list of subsets, acquired statically or dynamically.

21. Navigator according to claim 12, wherein the navigator establishes an asynchronous or synchronous communication channel between other users of the content or predefined persons or applications by selecting an area or a point on the navigator area.

22. Navigator according to claim 12, wherein the data processing device is contained in or connected to a computing device, TV set or handheld communication device.

23. Navigator according to claim 12, wherein the navigator only presents content that is suitable for the capacity of the device used, due to known limitations in processing, display or communication channels.

24. Navigator according to claim 12, wherein the navigator is always displayed in front of, and partly disengaged from, other applications running in the data processing system.

25. Use of the navigator according to one of claims 12-24 for accessing, publishing, and navigating in educational content.

26. A computer implemented method for interacting, accessing, publishing, and/or navigating in a digital education space in which all content is tagged, the method comprising:
displaying a movable, expandable and collapsible navigator area in front, on a display or projecting means connected to a data processing device,
selecting a point or an area on the navigator expressing the desired action, and
mapping the selected point or area on the education space for executing the desired action.

27. Method according to claim 26, comprising publishing content to the education space by indicating a point or an area on the navigator, whereby the content is appropriately tagged and subsequently published.

28. Navigating device for accessing, publishing, and/or navigating in a digital education space in which all content is tagged, comprising a movable, expandable and collapsible navigator area displayed on a display or projecting means connected to a data processing device interacting with the education space, the navigator area being displayed in front partly disengaged from other application programs running in the processing device and linked to the content in the education space by a mapping function.

29. Navigator according to claim 28, wherein the device is embedded in a learning management system, the navigator area giving access to administrative functions for a set of educational content.

30. Navigator according to claim 28, wherein the navigator area is divided into regions for accessing educational content, accessing resources, communicating with other users of the education space and communicating with the learning management system administrator.

31. Navigator according to claim 28, wherein the education space is a personal subset of an educational space for a group of users.

32. Navigator device according to claim 28, comprising an education tracking device monitoring the content experienced by the user, the education tracking being graphically displayed on the navigator area.

33. Navigator according to claim 26, wherein navigational buttons on the navigator area giving access to coaching, setting bookmarks and linking to other related content with an URL (universal resource locator).

34. Computer program product for a data processing system comprising a computer readable medium, having thereon a computer readable program means which, when loaded into an internal memory of a data processing system, makes the data processing system perform the method in claim 1 or claim 26.

35. Computer program product for a data processing system comprising com puter readable code means which, when loaded into an internal memory of a data processing system, makes the data processing system perform the method in claim 1 or claim 26.
